(19) United States
(12) Patent Application Publication
(10) Pub. No.: US 2009/0250998 A1
(43) Pub. Date: Oct. 8, 2009

(54) Electronic Control Unit With Cooling by Means of a Valve Block

(75) Inventors: Axel Hinz, Neu-Anspach (DE); Günther Vogel, Dreieich (DE); Uwe Greiff, Bad Homburg (DE); Rene Lenz, Frankfurt (DE); Christoph Köhler, Kelkheim (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 11/920,807

(22) PCT Filed: May 16, 2006
(86) PCT No.: PCT/EP2006/062331

§ 371 Date: Mar. 6, 2008

(30) Foreign Application Priority Data
May 24, 2005 (DE) 102005023837.8

(51) Int. Cl. B60T 8/36

(52) U.S. Cl. 303/119.3

(57) ABSTRACT

Disclosed are hydraulic/electronic control units (1, 2) for an electronic brake control system. A hydraulic/electronic control unit of current ABS/TCS/ESP systems essentially includes a central hydraulic block (6) and an electronic control unit (1) including control electronics on a control circuit board (4). The circuit board (4) is structured in such a way that it is insulated completely towards the outside on at least one first side (28) and includes an essentially smooth surface. Thus it is possible to use the hydraulic block (6) for cooling the circuit board (4).

### BACKGROUND OF THE INVENTION

The invention relates to the sector of hydraulic/electronic control units for an electronic brake control system. A hydraulic/electronic control unit for current ABS/TCS/ESP systems comprises a central hydraulic block (with valves and an integrated pump as well as an electric motor flanged to the hydraulic block) and an electronic control unit including control electronics on a control circuit board. Said control units are well-known and have been disclosed e.g. in the following German patent applications: 19500350, 1961297, 10355910 (P7787, P8601, P10719). Such control units are required in large quantities so that there is a need to simplify their construction.

It is therefore the object of the present invention to describe an electronic control unit with a simple construction as well as an electronic control unit with a cost-effective construction, which includes the control unit and the hydraulic block. Regarding the control unit, the invention basically consists in that one side of the circuit board is smooth and completely insulated. This results in several advantageous possibilities for utilizing the circuit board, as is explained later on.

It is therefore possible to connect the circuit board in such a way with the housing of the electronic control unit that it essentially forms the outside of the housing of the control unit at the same time. Therefore, the housing of the control unit can be manufactured in one piece and is closed on one side by the circuit board.

Essentially, the invention with regard to the control unit consists in that the first side of the circuit board forming the closure of the control unit abuts on the adjacent surface of the hydraulic block so that the hydraulic block can be used at the same time for cooling the heat generated on the circuit board. This possibility is very important because the circuit board is increasingly equipped with electronic components which locally develop an intense heat. It is not necessary that the circuit board bears immediately against the corresponding surface of the hydraulic block. Also an intermediate layer, e.g. in the form of a foil, may be provided which is electrically insulating, but presents a good property of conducting heat. In this case, the first side of the circuit board can also be provided with strip conductors.

Since the circuits on the circuit board serve for actuating the valves in the hydraulic block, there must be a possibility within the framework of the present invention of actuating the electrically operating valves integrated into the hydraulic block with the corresponding electrical signals. In principle, this means that the first side of the circuit board is provided with islands which are excluded from the complete insulation of this layer and are equipped with electrically conducting contact surfaces. If the contact surfaces, e.g. for compensating position tolerances of the board, have particularly large dimensions, it might be useful to arrange also for recesses near the contact surfaces in the block, in addition to the valves. This possibility may also be arranged for with regard to electrical plug contacts which are anchored in the circuit board of the control unit, project over the plane of the first side of the circuit board in the direction of the hydraulic block and could be short-circuited by it.

The invention is also suited for a control unit in which the coils of the magnets actuating the valves are embedded in the valve block. This embodiment is not the object of the invention at issue and is described in detail in a parallel application. Since the first side of the circuit board should preferably abut on the surface associated to the hydraulic block, there is the difficulty that hereby the position of the circuit board with regard to the hydraulic block is fixed. At the same time, a permanently good electric connection of the contact surfaces to the valve coils has to be ensured. The elastic contact means (bridging the possible air gap which might interrupt the electric connection) guarantee in any case an electric connection. Another possibility may consist in the coils being connected to the circuit board by means of a known contact blades. In this case the contact blades engage into corresponding contact openings when control unit and hydraulic block are assembled, ensuring a good and permanent contact due to the material abrasion caused by the assembly process.

The contact means have to be securely retained on the first side of the circuit board or on the valve housings. In this case, the contact means are preferably anchored first by casting them into so-called pre-molded parts which in a further step are cast with the first circuit board or the valve housings. As described in the following examples, the contact means can be e.g. spiral springs (FIG. 4) or spring arms (FIG. 5) which are fixed to the circuit board and/or the coil or the valve block.

Finally, there is the problem that a motor is flanged to the side of the hydraulic block remote from the control unit, the motor driving the pump integrated into the hydraulic block and having to be operated by the circuit board. Thus, an opening extending through the valve block and the circuit board is created in which a suitable plug-in connection between the control unit and the motor can be accommodated.

In the following one embodiment of the invention is explained on the basis of the accompanying drawings.

### BRIEF DESCRIPTION OF THE DRAWINGS

In the drawings:

FIG. 1 is a perspective view of the hydraulic/electronic control unit for a controlled brake system;

FIG. 2 is an enlarged portion of the hydraulic/electronic control unit according to FIG. 1 in a broken-out and cross-sectional view with one possible first connection type between coils and circuit board;

FIG. 3 a view of a partial cross-section of the hydraulic/electronic control unit according to FIG. 1 with one possible second connection type between coils and circuit board;

FIG. 4 is a perspective view of the contact means according to FIG. 2 on an enlarged scale; and

FIG. 5 is an enlarged and partial cross-sectional view of the second connection type according to FIG. 3.

### DETAILED DESCRIPTION OF THE DRAWINGS

The principle operating mode of the hydraulic/electronic control unit described in the following has already been explained several times (e.g. in the German patent application P 19500350 (P7787)) and is described in the following only to the extent relevant for the invention. As for the rest, reference is made to the said patent application.

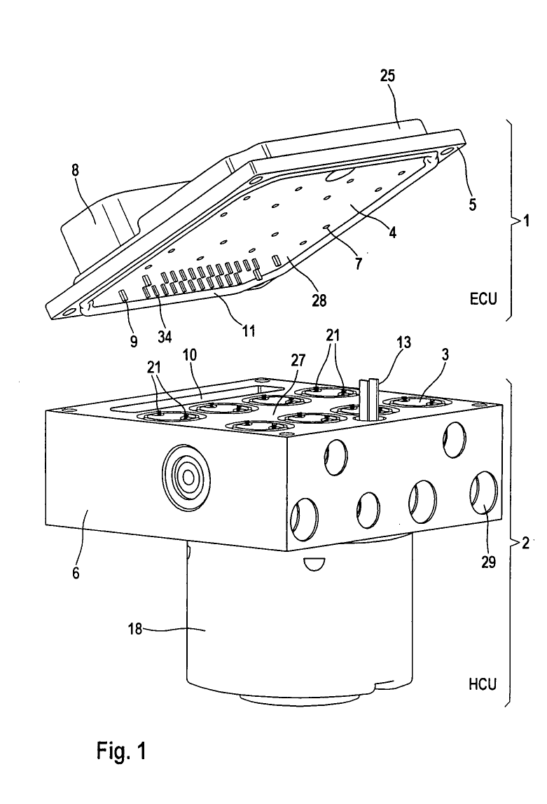

The Figures represent an electronic control unit 1 (in the following often also called ECU) and a connection (2) consisting of a valve block and a motor flanged to it, in the following often described as HCU. The HCU 2 consists of a valve block 6 and an electric motor 18 flanged to it. The ECU 1 essentially consists of a housing 25 and an electronic board 4, in the following often described as circuit board 4. In FIG. 1 the housing 25 is open on the bottom side and is closed by the circuit board 4 which abuts on corresponding projections of housing 25. On its circumferential side wall, housing 25 is provided with a groove in the frontal surface serving as bearing surface 5, a seal 11 being inserted in the groove. For the invention it is important that housing and circuit board 4 are more or less flush and that the circuit board 4 is essentially flat and smooth, unless there are possible and justified exceptions. In this way the circuit board forms at the same time also a closure for the housing 25 by which the electronic components provided on the circuit board and not indicated in the figure are encapsulated and thus protected from environmental influences to a large extent. Furthermore, a closed and functioning unit, requiring only little space and which can simply be handled, is thus created and can simply be used as replacement part.

The HCU 2 consisting of a valve block 6 (often also called hydraulic block) and a motor 18 has an aluminum block as valve block 6 provided with bores 30 which, among other things, are location bores for valves 3 and conduits 29 for the hydraulic fluid. The upper surface 27 of valve block 6 and the bottom surface 28 of circuit board 4 are close to each other. A motor 18 is flanged to the valve block 6 and drives a pump in the valve block, which is not described in detail in the Figure.

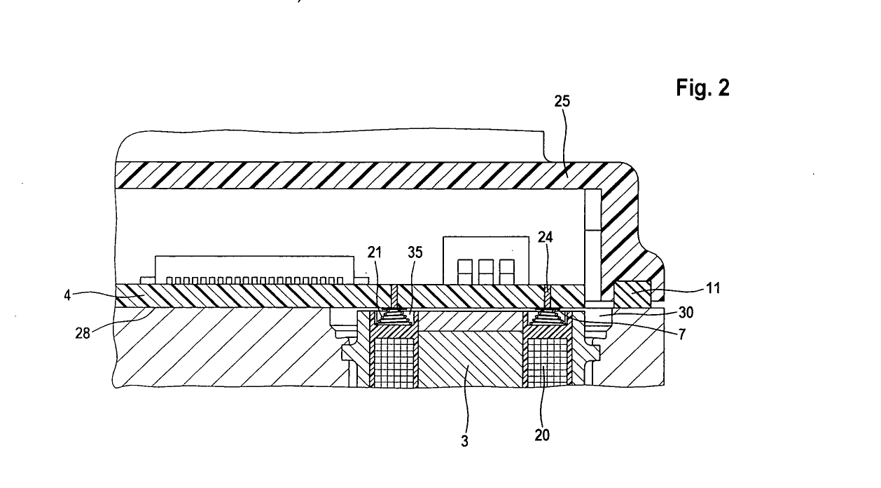

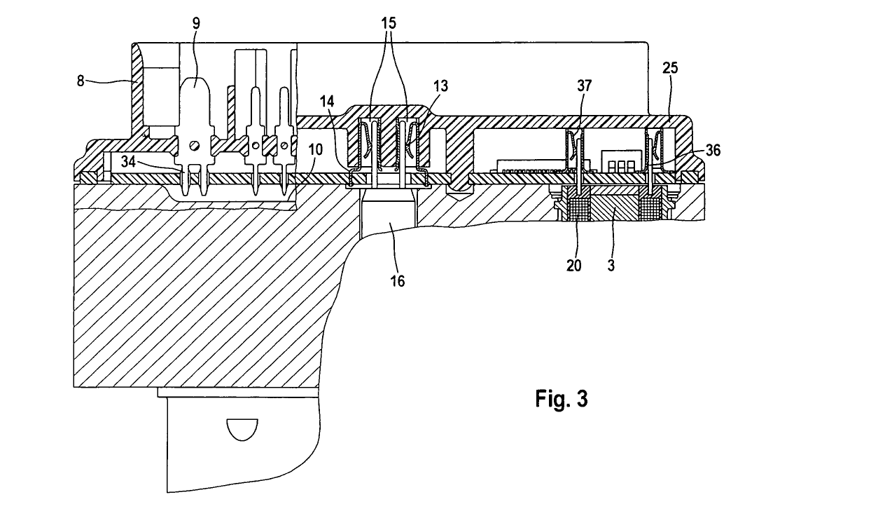

It is also particularly important for the invention that the bottom surface 28 of the circuit board 4 abuts directly on the upper surface 27 of valve block 6, as can be seen particularly from FIG. 2 and FIG. 3. Since valve block 6 is made of aluminum which is a very good heat conductor, the heat produced by the electronic components on circuit board 4 can be dissipated easily by means of valve block 6. This is a considerable advantage in view of the fact that the circuit boards are equipped in an increasingly compact manner with electronic components so that the circuit board has still relatively small dimensions.

It has to be considered, however, that aluminum is also a good electric conductor so that care has to be taken that by abutting the circuit board 4 on the upper surface 27 of the hydraulic block 6 no electric short-circuits are caused. This is achieved by maintaining the bottom surface 28 of the circuit board free from openly accessible electric lines, thus no short-circuits being possible.

However, it might not be avoided that metallic conductors extend through the circuit board 4, e.g. if the contacts 9 of a central plug 8 have to be securely anchored on the circuit board and the fastening ends 34 extend through the circuit board 4. If it is not possible to manage without connecting the contacts 9 on circuit board 4 in such a way, it is recommended to provide a corresponding recess 10 in valve block 6.

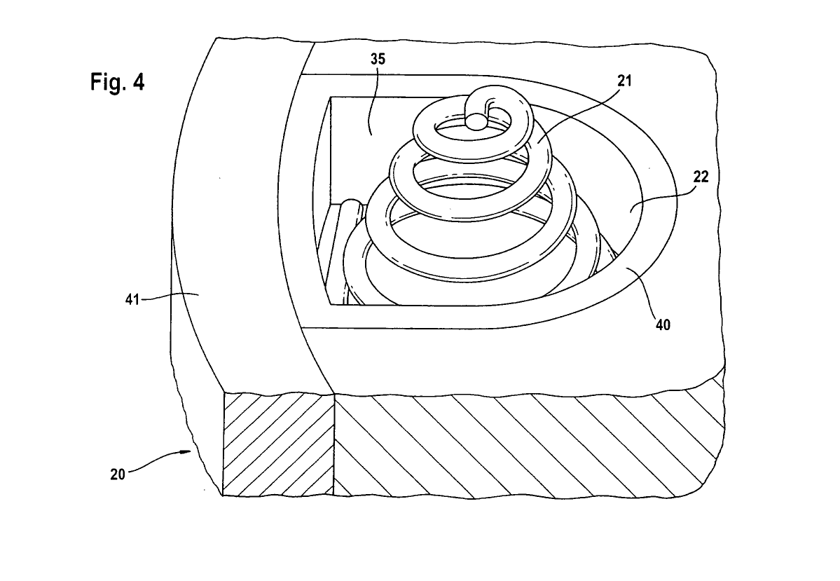

The valves 3 in valve block 6 have to be electrically actuated by the electric components on circuit board 4. This has to be considered in the embodiment of the bottom surface 28 of circuit board 4. A first possible type of connection is shown in FIG. 2 and FIG. 4 where small contact surfaces 7 on the bottom surface 28 are connected with corresponding components on the circuit board 4 by means of through-plating. First of all it has to be ensured that these contact surfaces 7 cannot get into contact with the upper surface 27 of valve block 6. The bore 30 accommodating the relative valve must therefore have an appropriate diameter.

In order to ensure also that the valves 3 have in any case contact to the contact surfaces 7, irrespective of how much distance there is between the valves and the upper surface 27 of valve block 6, the contact is made by wire springs 21 which abut on the valves 3 or their coils 20 and are electrically connected to the coils 20 of the valves 3. The construction of the valves is not the object of the present invention. It is only important that the coils are provided with elastic contact means being able to compensate for the different distances between coils and contact surfaces 7. Therefore, each coil is equipped with two wire springs 21 which are connected to the two ends of the coils 20. It is also possible manage with one single contact leading the second contact, which otherwise is necessary, via the aluminum block as ground. The wire spring 21 is accommodated in a pre-molded part 40 presenting a chamber 35 in which the wire spring 21 is inserted. The pre-molded part is cast with the housing 41 of the coil (cf. FIG. 4).

Another possibility of ensuring the contact might consist in selecting a cutting/plug-in connection for the electric connection between circuit board and the coils 20, the valves 3 being e.g. provided with plug-in supports, to which the cutting connection of the circuit board is attached. It is, however, essential that a separable, electrically conductive connection is ensured since, as already mentioned above, the housing 25 has to be exchangeable as a unit together with the circuit board.

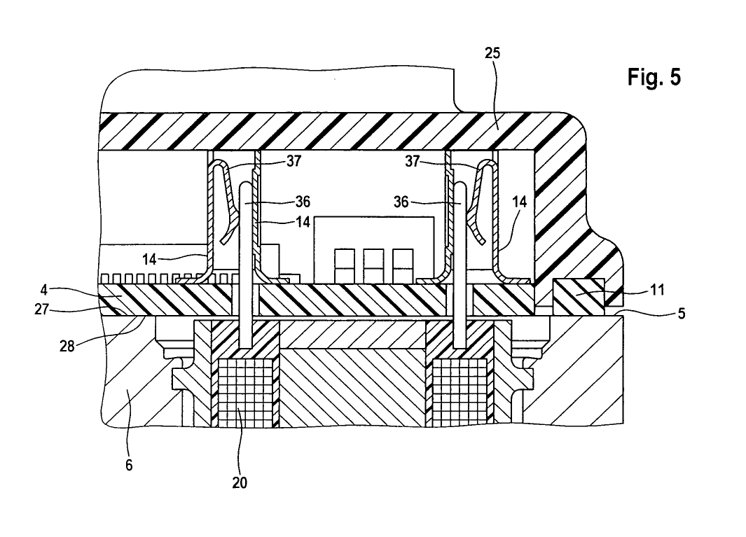

Another possibility of connecting the coils 20 with the circuit board 4 is provided given by that the connection method between motor 18 and control unit 1, described below, is applied analogously. This is described more in detail in FIG. 3 and FIG. 5 as second connection method. Herein, the coils 20 or their housing are equipped with contact pins 36 extending through the circuit board 4 and abutting on contact springs 37 being fixed on the circuit board 4. In order to prevent the pins and the retaining arms of the contact springs from being deformed, they are supported by projections on the inside of the housing. By means of the analogous connection method the motor plug 16 creates an electric connection between circuit board 4 and motor 18 described in FIG. 1, the motor plug 16 extending through hydraulic block 6.

Furthermore, it has to be considered that the position of the circuit board 4 with regard to the housing 25 and also the position of the housing with regard to the valve block 6 are fixed. Therefore, the circumferential elastic seal 11 has to project slightly from the circumferential abutment surface 5 of the side wall of housing 25, when the device is not assembled, in order to ensure that the bottom surface 28 of circuit board 4 can abut in any case on the upper surface 27 of valve block 6 when the device is assembled. This is presented on an enlarged scale in FIG. 5 and can also be seen well in FIG. 3.

Further important features can be derived from the following summary. It is the object of the present invention to describe a new type of ECU and the new type of electric connection of the valves 3 and the motor 18 to the board 4 included in ECU 1, resulting herefrom.

FIG. 1 shows a view of the new ECU 1 with the corresponding HCU 2. On the bottom side of the ECU, oriented in the direction of the valves 3, one does not find the usual shaft-type forms accommodating valve coils, but only the surface of the electronic board 4 included in the ECU. The surface of the board is flush with the circumferential abutting surface 5 of the ECU on hydraulic block 6. Thus, the board is also abutting on the hydraulic block 6 ensuring a good dissipation of the heat caused in the electronics.

By means of modern multi-layer technology it can be achieved that on this side of the board there are no strip conductors, but only contact surfaces 7 providing the power supply for the valves. The electronic components are arranged on the side remote from valve block 6. This prevents short-circuit when the board abuts on the block. The risk of a short-circuit exists only where the central plug 8 gets into contact with the board by means of the projecting contacts 9. Therefore, a recess 10 is provided on the opposite side, in the hydraulic block, which ensures a sufficient distance of the aluminum block to the contacts.

Due to the simple structure of the ECU 1 it is possible to manufacture the plastic housing of the ECU in one piece. It is not necessary to put a cover on the ECU 1 and to weld it or seal it in another way after having inserted the board 4. The HCU 2 is sealed with regard to valve block 6 by a circumferential seal 11, which is directly injected on housing 6 or can be inserted in a circumferential groove.

FIG. 2 and FIG. 3 show different contact types which can be applied appropriately in this ECU concept.

The contacts 9 of central plug 8 are connected to the board 4 by means of press-fit contacts. Motor 18 (FIG. 1) is supplied with power by means of a socket-plug connection 13. The socket 14 is soldered in or on the board. It is mechanically led through a double shaft 15 into which it slides during the assembly. The motor plug 16 can be directly included in the motor (not represented here) or executed as a component which can be mounted irrespective of the direction and which is put in a socket on the board as well as on the motor. The valves 3 are connected to the contact surfaces 7 on board 4, e.g. by means of a spring contact 21.

FIG. 3 shows, among other things, a portion of valve 3 in a longitudinal cross-section. As one can see, the valve coil 20 is installed on the inside of the valve, but outside of the area filled with brake fluid (and is included in the ECU 1, as it was usual up to now). Since the ECU and its board 4 shall be a replacement part, there is a separable and—with regard to the incorporation—tolerant connection between ECU 1 and vale 3. By simplifying the construction of the ECU and the board 4 therefore abuts directly on the hydraulic block, the resulting connection system is a very compact one.

According to FIG. 3 and FIG. 4, this is achieved by a cone-shaped wire spring 21 which is embedded in a box-shaped plastic element 22, the box-shaped plastic element 22 being a pre-molded part. The base of the spring leads through the bottom of the plastic element to the proper coil 20 which after having been completed is covered with plastic. Preferably, the plastic case 22 is manufactured together with the spring as a pre-molded part for the manufacturing of the coil. After bringing the coil wire into contact with the base of the wire spring, the pre-molded part is injection-molded with plastic together with the coil. Then the components injection-molded and electrically connected form a component which is easy to handle.

The wire spring 21 presses against the contact surface 7 on the bottom side 28 of circuit board 4. The contact surface 7 is connected with the different board planes and the components by means of through-plating 24, according to the corresponding board technology. During operation the wire spring 21 ensures an electric contact which is not interrupted by vibrations. It also compensates shiftings of board 4 and ECU housing 25 as well as manufacturing tolerances due to thermal influences.

1.-8. (canceled)

9. An electrohydraulic control unit (1, 2) for an electronic brake control system with a housing (25) accommodating a circuit board (4) with a first and a second side, the first side being completely electrically insulated to the outside with an essentially smooth surface and the second side being equipped with electronic components.

10. The electronic control unit according to claim 9, wherein the housing is open to one side and the circuit board (4) is inserted in such a way in the housing (25), that the second side is oriented towards the inside of the housing (25) and the first side (28) of circuit board (4) is oriented away from the inside of the housing.

11. The electronic control according to anyone of claim 10, wherein the circuit board (4) and the valve block (6) are provided with through-bores (30) being flush to each other, serving for accommodating a plug-in connection (16) extending through them.

12. The electrohydraulic control unit according to claim 9, comprising a valve block (6) operated by the control unit (1) and accommodating valves, wherein the valve block consists of a heat-conducting material, and wherein the first side (28) of the circuit board (4) is arranged facing the valve block at such a close distance that at least a portion of the heat produced by the control unit (1) is received or dissipated by the valve block (6).

13. The electrohydraulic control according to claim 12, wherein the first side (28) of circuit board (4) is provided with local contact surfaces (7), which are connected to electric circuits on the circuit board (4), and that the surface (27) of the valve block (6) close to the first side (28) of the circuit board is provided with recesses (30) associated with the contact surfaces (7).

14. The electrohydraulic control according to claim 13, wherein the contact surfaces (7) are connected to the electric coils (20) associated with the contact surfaces (7) with connectors, the coils being accommodated in the valve block (6) and serving for actuating the valves (3) inserted in the valve block.

15. The electronic control according to claim 14, wherein the connectors are electrically conducting contact members (21), which are resiliently preloaded in the direction of the connection between the control unit (1) and valve block (6).

16. The electronic control according to claim 15, wherein the contact members are injection-molded into pre-molded parts (22).
